(19) United States
(12) Patent Application Publication
(10) Pub. No.: US 2018/0244504 A1
(43) Pub. Date: Aug. 30, 2018

(54) AUTOMOTIVE RECOVERY COUPLER

(71) Applicant: Maxtrax Australia Pty Ltd., Geebung (AU)

(72) Inventor: Bradley John McCARTHY, Nundah (AU)

(73) Assignee: Maxtrax Australia Pty Ltd., Geebung (AU)

(21) Appl. No.: 15/902,132

(22) Filed: Feb. 22, 2018

(30) Foreign Application Priority Data
Feb. 27, 2017 (AU) 2017900663

(51) Int. Cl. B66C 1/66; B66D 1/36

(52) U.S. Cl. CPC B66C 1/66; B66D 2700/026; B66D 1/36

(57) ABSTRACT

The present invention relates to an automotive recovery coupler for coupling a shackle to a winch line. The coupler includes a receiver for receiving the fastened shackle, and a guide for guiding the winch line. The receiver is typically annular in shape and the winch line passes through the shackle. The coupler may or may not include moving parts.

### TECHNICAL FIELD

The present invention relates to an automotive recovery coupler. The present invention has particular, although not exclusive application to extracting a stuck four-wheel-drive (4WD) vehicle using a winch.

### BACKGROUND

The reference to any prior art in this specification is not, and should not be taken as an acknowledgement or any form of suggestion that the prior art forms part of the common general knowledge.

There are a host of automotive recovery devices available for extracting stuck 4WD vehicles from mire such as sand and mud.

Snatch straps are designed to stretch under load and can be coupled between the stuck vehicle and a moving vehicle that pulls the stuck vehicle from the mire.

Many 4WD vehicles are fitted with winches which can be used in extreme recovery situations.

The applicant has perceived the need for an alternative automotive recovery device.

### SUMMARY OF THE INVENTION

According to one aspect of the present invention, there is provided an automotive recovery coupler for coupling a shackle to a winch line, the coupler including:

a receiver for receiving the fastened shackle; and

a guide for guiding the winch line.

Preferably, the coupler is of simple and durable construction, including no moving parts.

The receiver may include an aperture through which the shackle passes. The receiver may include a rotation impeder to impede rotation of the coupler during winching of the winch line. The rotation impeder may include one or more grooves for receiving the shackle.

The receiver may include a bobbin. The bobbin may be metal. The receiver may include a cover for covering the bobbin. The cover and bobbin may form a tongue-in-groove fit. The cover may be an overmold. The overmold may include nylon material. The overmold may include polymeric or plastic material.

The receiver may further include a seat upon which the bobbin sits. The bobbin may be able to rotate on the seat to reduce wear of the winch line. The seat may include a cradle for cradling the bobbin. The seat may include two annular parts. The seat may be formed from polymeric material. The coupler may include a lubricator for lubricating the bobbin. The lubricator may include a sealable inlet in the cover for receiving lubricant. The lubricator may include passages for transporting lubricant to the bobbin. The passages may further transport lubricant to the seat. The coupler may include one or more seals for containing the lubricant within the coupler.

The guide may include an endless recess passing around the bobbin. The guide may include a smooth surface over which the winch line slides. The surface may be polished. The surface may be arcuate. The winch line may pass through the shackle.

According to another aspect of the present invention, there is provided an automotive recovery coupler assembly including:

the automotive recovery coupler; and

a shackle for fastening to the receiver.

The assembly may further include winch line for being guided by the guide. Preferably, the shackle is a soft shackle. The soft shackle may include a head for being received within a tail. Preferably, the winch line is a synthetic winch line. The coupler may be annular.

According to another aspect of the present invention, there is provided a recovery method for recovering a stuck vehicle bearing a winch using an automotive recovery coupler, the method involving:

fastening a shackle to a receiver of the coupler and a stationary object; and

guiding moving winch line of the winch using guide of the coupler to extract the vehicle.

The stationary object may be another vehicle.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of an automotive recovery coupler assembly in accordance with an embodiment of the present invention;

FIG. 2 is a sectioned perspective view of the automotive recovery coupler assembly of FIG. 1; and

FIG. 3 is a sectioned perspective view of an annular recovery coupler in accordance with another embodiment.

### DETAILED DESCRIPTION OF PREFERRED EMBODIMENTS

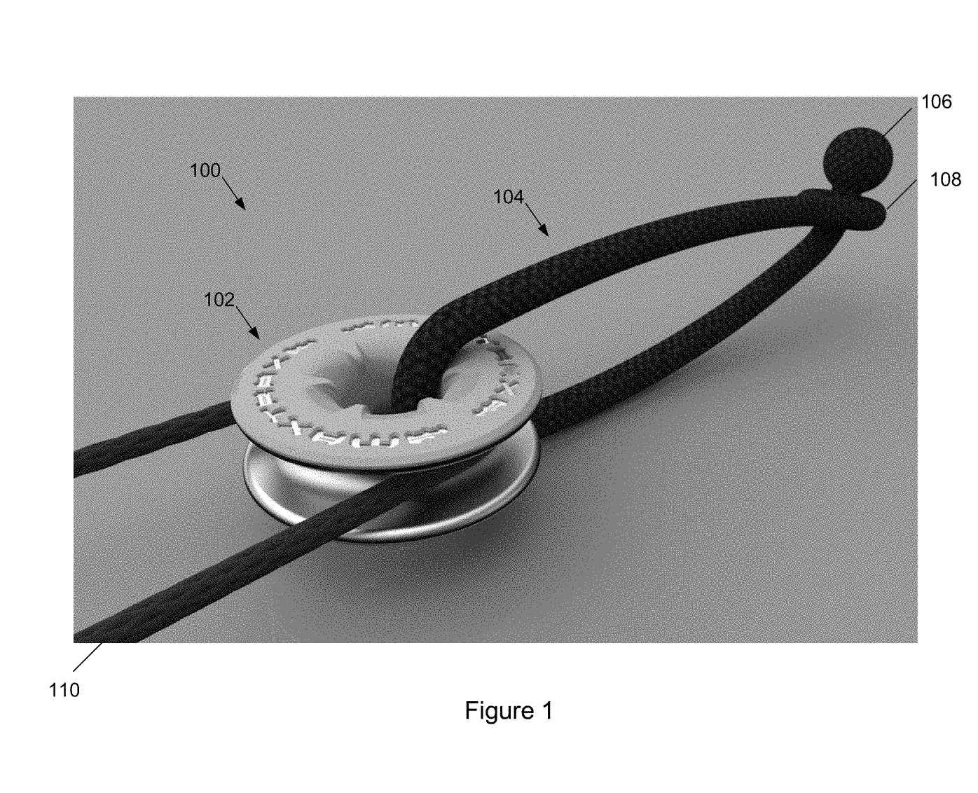

According to an embodiment of the present invention, there is provided an automotive recovery coupler assembly 100 as shown in FIG. 1. The assembly 100 includes an annular recovery coupler 102, and a soft shackle 104 for fastening to the coupler 102. The resilient soft shackle 104 includes an enlarged head 106 for being received within and force fitted through a tail 108. The assembly 100 further includes a synthetic winch line 110 for being guided by the coupler 102 during vehicle recovery.

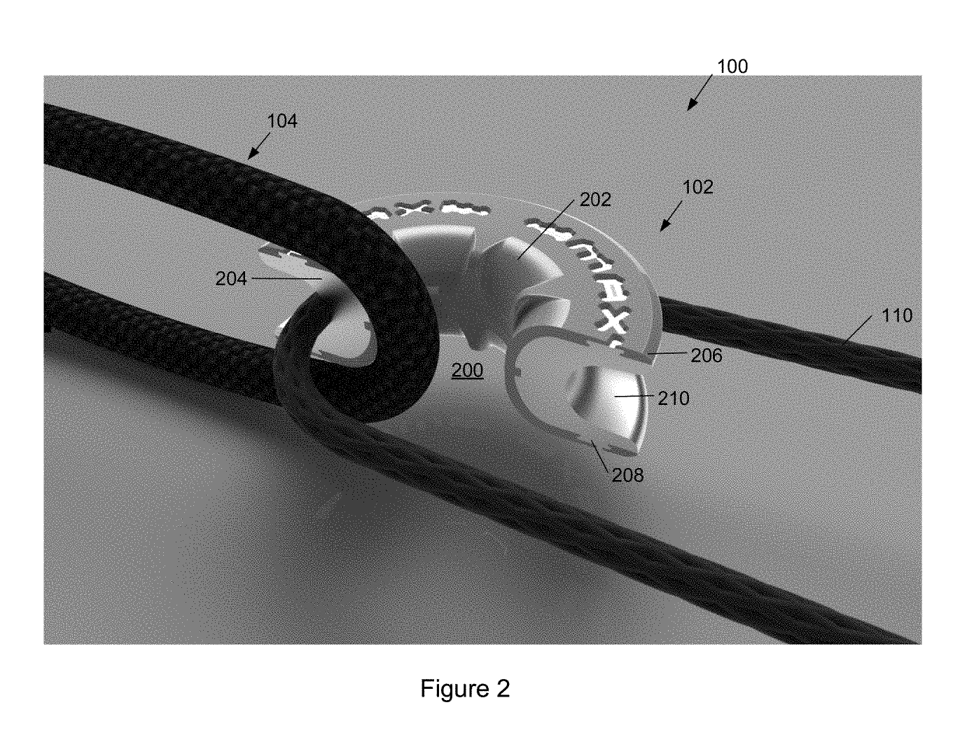

FIG. 2 more clearly shows the automotive recovery coupler 100 coupling the shackle 104 to the winch line 110. The coupler 100 includes a central fastening means 200 (i.e. annular receiver) for fastening the shackle 104. The fastening means 200 is in the form of an aperture through which the shackle 104 passes. The fastening means 200 defines vertical grooves 202 for receiving the shackle 104 to impede rotation during winching.

The fastening means 200 further includes a metal (e.g. aluminium) bobbin 204. The fastening means 200 also includes a cover 206 for covering the bobbin 204. The cover 206 is overmolded over the bobbin 204 from nylon or other like polymeric material. The cover 206 and bobbin 204 together form tongue-in-groove fits 208 to impede separation.

The recovery coupler 100 further includes guide means 210 for guiding the moving winch line 110. The guide means 210 is in the form of an endless recess passing around the edge of the bobbin 204. The guide means 210 includes a smooth polished surface over which the winch line 110 slides as it also passes through the shackle 104. The internal surface is arcuate.

Advantageously, the coupler is of simple and durable construction, including no moving parts.

A recovery method for recovering a stuck vehicle bearing a winch using the automotive recovery coupler assembly 100 is now briefly described.

Initially, the method involves fastening the shackle 104 to itself, and between the fastening means 200 of the coupler 102 and a stationary vehicle (i.e. object).

The winch line 110 is extended from the stuck vehicle, inserted through the guide means 210 and then attached to the stuck vehicle once more. The winch is then activated to pull in the winch line 110.

The moving winch line 110 slides through the guide means 210 of the coupler 102 to pull the stuck vehicle free from the mire.

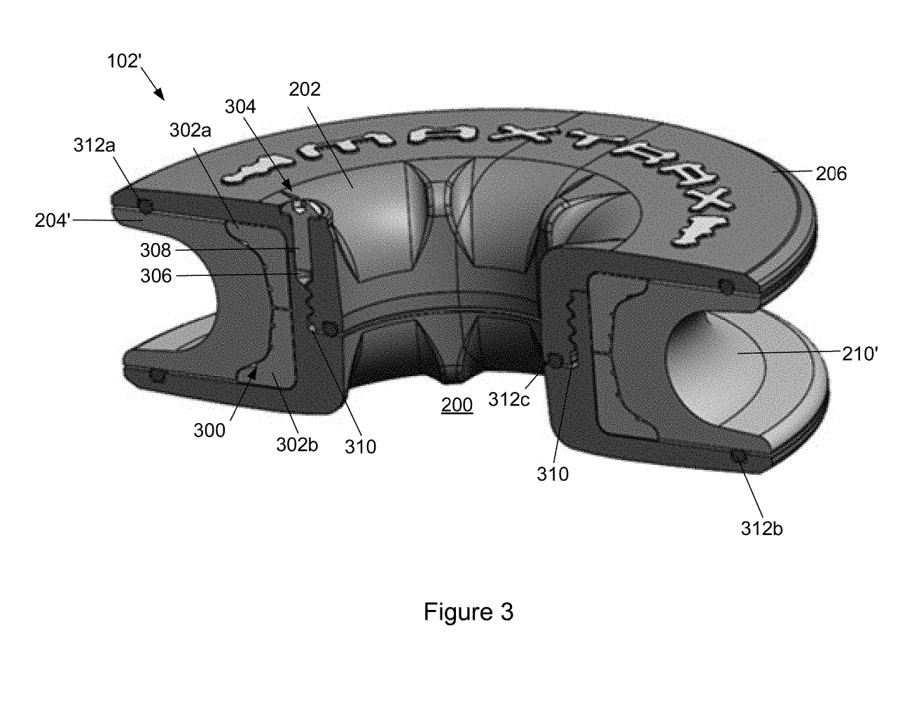

An alternative annular recovery coupler 102′ is shown in FIG. 3 where like numerals refer to like features previously described.

The fastening means 200 (or receiver) further includes a base seat 300 upon which the bobbin 204′ sits. The bobbin 204′ is advantageously able to rotate on the seat 300, in use under extreme tension, to reduce wear of the winch line 110. The seat 300 includes two annular parts 302a, 302b of polymeric material, that together form a cradle for cradling the bobbin 204′.

The coupler 102′ includes a lubricator 304 for lubricating the bobbin 204′ and the seat 300 in the cover 206. The lubricator 304 includes an inlet 306 in the cover 206 for receiving lubricant (e.g. grease) from a lubricant gun. The inlet 306 is sealed with a screw 308. The lubricator 304 include passages 310 for transporting lubricant from the inlet 306 to the bobbin 204′ and seat 300. Lubricant completely surrounds the seat parts 302a, 302b and an inner surface of the bobbin 204′.

The coupler 102′ includes three O-ring seals 312a, 312b, 312c for containing the lubricant within the coupler 102′.

A person skilled in the art will appreciate that many embodiments and variations can be made without departing from the ambit of the present invention.

In one embodiment, the stuck vehicle does not have a winch, and the stationary vehicle instead uses its winch in conjunction with the automotive recovery coupler assembly 100 to extract the stuck vehicle.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or can embodiment′ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. An automotive recovery coupler for coupling a shackle to a winch line, the coupler including:
a receiver for receiving the fastened shackle; and
a guide for guiding the winch line.

2. A recovery coupler as claimed in claim 1, wherein the receiver is annular and includes an aperture through which the shackle passes.

3. A recovery coupler as claimed in claim 1, wherein the receiver includes a rotation impeder to impede rotation of the coupler during winching of the winch line.

4. A recovery coupler as claimed in claim 3, wherein the rotation impeder includes one or more grooves for receiving the shackle.

5. A recovery coupler as claimed in claim 1, wherein the receiver includes a bobbin.

6. A recovery coupler as claimed in claim 5, wherein the bobbin is made of metal.

7. A recovery coupler as claimed in claim 5, wherein the receiver includes a cover for covering the bobbin.

8. A recovery coupler as claimed in claim 5, wherein the receiver further include a seat upon which the bobbin sits.

9. A recovery coupler as claimed in claim 8, wherein the bobbin is able to rotate on the seat, in use, to reduce wear of the winch line.

10. A recovery coupler as claimed in claim 8, wherein the seat includes a cradle for cradling the bobbin.

11. A recovery coupler as claimed in claim 8, wherein the seat includes two annular parts.

12. A recovery coupler as claimed in claim 5, further including a lubricator for lubricating the bobbin.

13. A recovery coupler as claimed in claim 12, wherein the lubricator includes a sealable inlet for receiving lubricant, and passages for transporting lubricant to the bobbin.

14. A recovery coupler as claimed in claim 12, wherein the passages further transport lubricant to a seat upon which the bobbin sits.

15. A recovery coupler as claimed in claim 12, further including one or more seals for containing lubricant within the coupler.

16. A recovery coupler as claimed in claim 1, wherein the guide includes an endless recess.

17. A recovery coupler as claimed in claim 1, wherein the guide includes a smooth arcuate surface over which the winch line slides.

18. A recovery coupler as claimed in claim 1, wherein the winch line passes through the shackle.

19. An automotive recovery coupler assembly including:
an automotive recovery coupler as claimed in claim 1; and
a shackle for fastening to the receiver.

20. A recovery method for recovering a stuck vehicle bearing a winch using an automotive recovery coupler, the method involving:
fastening a shackle to a receiver of the coupler and a stationary object; and
guiding moving winch line of the winch using guide of the coupler to extract the vehicle.
